(19) United States
(12) Patent Application Publication
(10) Pub. No.: US 2019/0015736 A1
(43) Pub. Date: Jan. 17, 2019

(54) CUBE SET OPERATING BASED ON SHORT-DISTANCE WIRELESS COMMUNICATION AND METHOD AND SYSTEM FOR RECOGNIZING CUBE PATTERN USING SAME

(71) Applicant: ATTOCUBE CO., LTD., Seongnam-si, Gyeonggi-do (KR)

(72) Inventors: Sang Taek HAN, Seongnam-si, Gyeonggi-do (KR); Sung Hyuk MOON, Seongnam-si, Gyeonggi-do (KR)

(21) Appl. No.: 16/073,749

(22) PCT Filed: Feb. 9, 2017
(86) PCT No.: PCT/KR2017/001400

§ 371 Date: Jul. 27, 2018

(30) Foreign Application Priority Data
Feb. 11, 2016 (KR) 10-2016-0015774
Feb. 11, 2016 (KR) 10-2016-0015776

(51) Int. Cl. A63F 9/10; A63F 9/08; G01C 17/38; G06K 19/07

(52) U.S. Cl. CPC A63F 9/10; A63F 9/0803; A63F 2009/0846; G01C 17/38; G06K 19/07; A63F 9/0826

(57) ABSTRACT

Provided is a cube set operating based on short-distance wireless communication and a method and system for recognizing a cube pattern using the same. The cube set includes a plurality of cubes having different patterns formed on faces and a cube case in which a plurality of partition spaces where the plurality of cubes is respectively seated has been formed. One or more magnetic bodies are formed in at least some of the faces of the cube, and a plurality of magnetic sensors is formed in each of the partition spaces of the cube case.

### CROSS REFERENCE TO RELATED APPLICATION

The present application claims the benefit of Korean Patent Applications Nos. 10-2016-0015774 and 10-2016-0015776 filed in the Korean Intellectual Property Office on Feb. 11, 2016, the entire contents of which are incorporated herein by reference.

### BACKGROUND OF THE INVENTION

### 1. Technical Field

The present invention relates to a cube capable of operating in conjunction with a terminal, such as a smartphone or a tablet, using short-distance wireless communication.

### 2. Description of the Related Art

A block set including a plurality of cubes and capable of combining various alphabetical letters is widely used for toy or learning.

A user who uses the block set can improve his or her perceptional space skills through a process of combining or fitting the cubes, and can learn basic letters through a process of combining the cubes in the case of a block set embodied from the alphabet or Hanguel consonants and vowels.

Korean Patent Application Publication No. 10-2006-0020940 (laid open Mar. 7, 2006) discloses a toy for learning in which the alphabet, such as the consonants and vowels of Hanguel, alphabetical and/or numerical information, is detachably attached to each of the faces of a cube and a user learns letters and words by arranging the alphabet within an arrangement plate and learns.

However, a conventional technology has a problem in that when a user randomly combines cubes, the user cannot be aware of a correct pattern or arrangement of the combined cubes unless the user has already been aware of the pattern or arrangement or has been informed of the pattern or arrangement by someone.

### SUMMARY OF THE INVENTION

An embodiment of the present invention provides a cube set in which a pattern and location of cubes are automatically recognized while operating in conjunction with a terminal using short-distance wireless communication, and a method and system for recognizing a cube pattern using the same.

Another embodiment of the present invention provides a method of operating in conjunction with a cube set, wherein the pattern and location of cubes can be automatically recognized by transmitting/receiving data to/from a terminal using short-distance wireless communication, and a terminal device for performing the method.

A cube set operating based on short-distance wireless communication according to an embodiment of the present invention operates in conjunction with the terminal device using short-distance wireless communication, and includes a plurality of cubes having different patterns formed on faces and a cube case in which a plurality of partition spaces where the plurality of cubes is respectively seated has been formed. One or more magnetic bodies are formed in at least some of the faces of the cube, and a plurality of magnetic sensors is formed in each of the partition spaces of the cube case.

A method of recognizing a cube pattern according to an embodiment of the present invention includes recognizing, by a terminal device capable of short-distance wireless communication, pattern of cubes, and includes displaying a target shape having a plurality of patterns, receiving magnetism information detected by magnetic sensors from a plurality of partition spaces in which a plurality of cubes is respectively seated and a cube case equipped with the plurality of magnetic sensors formed in the partition spaces, recognizing a pattern formed on the top of the cube based on the received magnetism information of the magnetic sensors, confirming whether any one of the patterns forming the target shape is matched with the recognized pattern of the cube, and displaying a result of the matching.

Furthermore, a system for recognizing a cube pattern according to an embodiment of the present invention includes a plurality of cubes having different patterns on respective faces, wherein one or more magnetic bodies are formed in at least some of the faces, a cube case in which a plurality of partition spaces where the plurality of cubes is respectively seated is formed and a plurality of magnetic sensors is formed in each of the partition spaces, and a terminal device receiving magnetism information detected by the magnetic sensors from the cube case and recognizing a pattern formed on the top of the cube based on the received magnetism information of the magnetic sensors.

The method of recognizing a cube pattern according to an embodiment of the present invention may be implemented as a program stored in a storage medium in order to be executed by a computer and a recording medium on which the program is recorded.

### BRIEF DESCRIPTION OF THE DRAWINGS

FIG. 1 is a block diagram showing a schematic configuration of a system for recognizing a cube pattern according to an embodiment of the present invention.

FIG. 2 is an exploded view showing an embodiment of patterns formed in the respective faces of a cube.

FIG. 3 is a block diagram showing an embodiment of the configuration of a terminal device.

FIG. 4 is a diagram showing a schematic operation of a system for recognizing a cube pattern according to an embodiment of the present invention.

FIGS. 5 and 6 are diagrams showing embodiments of target shapes used in the system for recognizing a cube pattern.

FIG. 7 is a flowchart showing a method of recognizing a cube pattern according to an embodiment of the present invention.

FIG. 8 is a block diagram showing the configuration of a system for recognizing a cube pattern based on short-distance wireless communication according to another embodiment of the present invention.

FIG. 9 is a diagram for illustrating an embodiment of the configuration of a cube and cube case shown in FIG. 8.

FIG. 10 is a diagram showing an embodiment of the configuration of a plurality of partition spaces formed in the cube case.

FIG. 11 is a diagram showing an embodiment of the internal configuration of the cube case.

FIG. 12 is a diagram showing an embodiment of the configuration of the faces of the cube in which magnetic bodies have been formed.

FIG. 13 is a diagram for illustrating an embodiment of a method of recognizing a pattern of cubes based on magnetism information of the magnetic sensors formed in the partition spaces of the cube case.

FIG. 14 is a diagram showing an embodiment of the configuration of the faces of the cube in which magnetic bodies and tags have been formed.

FIG. 15 is a diagram showing another embodiment of the configuration of a plurality of partition spaces formed in the cube case.

FIG. 16 is a diagram for illustrating another embodiment of a method of recognizing a pattern of cubes based on magnetism information of magnetic sensors formed in the partition spaces of the cube case.

FIG. 17 is a diagram for illustrating an embodiment of a method of recognizing a cube pattern using a cube operating based on short-distance wireless communication according to the present invention.

FIG. 18 is a flowchart showing a method of operating in conjunction with a cube case according to an embodiment of the present invention.

FIGS. 19 and 20 are diagrams for illustrating embodiments of methods of connecting to one of cube cases around the terminal device.

FIG. 21 is a diagram for illustrating an embodiment of a method of detecting the top area of the cube case.

### DETAILED DESCRIPTION

The following contents illustrate only the principle of the present invention. Although devices have not been clearly described or illustrated in this specification, those skilled in the art may implement various devices that implement the principle of the present invention and are included in the concept and scope of the present invention. Furthermore, it should be understood that in principle, conditional terms and embodiments listed in this specification are evidently intended only in order for the concept of the present invention to be understood and the range of right of the present invention is not restricted by the specially listed embodiments and states.

Furthermore, it is to be understood that all the detailed descriptions that list given embodiments in addition to the principle, aspects, and embodiments of the present invention are intended to include the structural and functional equivalents of such matters. Furthermore, it should be understood that the equivalents include equivalents to be developed in the future, that is, all devices invented to perform the same function by substituting some elements, in addition to known equivalents.

Accordingly, it should be understood that a block diagram of this specification, for example, is indicative of a conceptual viewpoint of an exemplary circuit that materializes the principle of the present disclosure. Likewise, it should be understood that all flowcharts, state change diagrams, and pseudo code may be substantially represented in computer-readable media and are indicative of various processes that are executed by computers or processors regardless of whether the computers or processors are evidently illustrated.

The functions of processors or the functions of various devices illustrated in the drawings that include function blocks illustrated as a similar concept may be provided by the use of hardware capable of executing software in relation to proper software, in addition to dedicated hardware. When being provided by a processor, the function may be provided by a single dedicated processor, a single sharing processor, or a plurality of separated processors, and some of them may be shared.

Furthermore, a processor, control, or a term suggested as a similar concept thereof, although it is clearly used, should not be construed as exclusively citing hardware having the ability to execute software, but should be construed as implicitly including digital signal processor (DSP) hardware, or ROM, RAM, or non-volatile memory for storing software without restriction. The processor, control, or term may also include known other hardware.

The above objects, characteristics, and merits will become more apparent from the following detailed description taken in conjunction with the accompanying drawings, and thus those skilled in the art to which the present invention pertains may readily implement the technological spirit of the present invention. Furthermore, in describing the present invention, a detailed description of a known art related to the present invention will be omitted if it is deemed to make the gist of the present invention unnecessarily vague.

Preferred embodiments in accordance with the present invention are described in detail below with reference to the accompanying drawings.

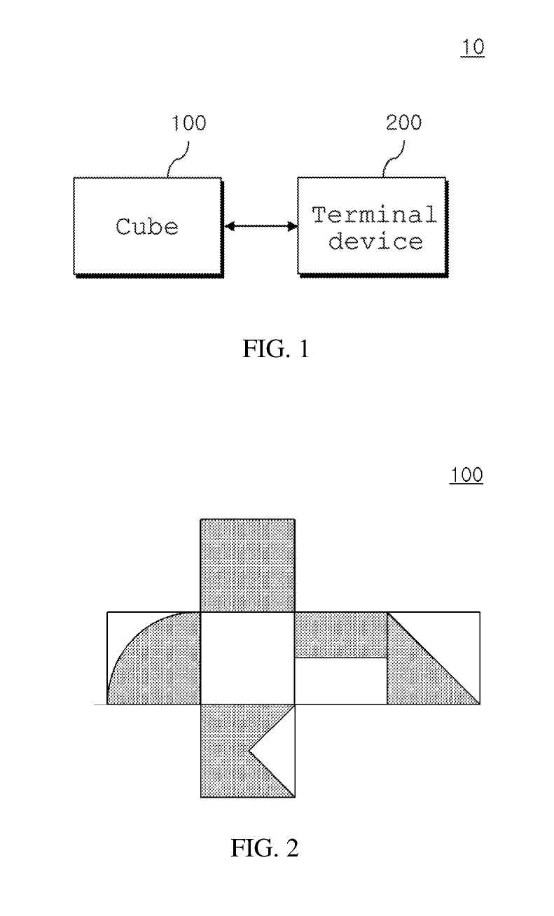

FIG. 1 is a block diagram showing a schematic configuration of a system for recognizing a cube pattern according to an embodiment of the present invention. The system for recognizing a cube pattern 10 may include a cube 100 and a terminal device 200.

Referring to FIG. 1, the cube 100 may have a regular hexahedron shape, and different patterns may have been formed in the respective faces of the cube 100.

The patterns formed in the faces of the cube 100 may have been derived by subdividing various alphabetic letters, numbers and symbols, extracting the directional characteristics of them, and arranging the directional characteristics.

For example, as shown in FIG. 2, a pattern of a fan shape that connects two neighboring sides in a curve may be formed in the first face of the cube 100. The second face of the cube 100 is a blank face. A rectangular pattern that connects two opposite sides and bisects the sides may be formed in the third face of the cube 100.

Furthermore, a pattern of an isosceles triangle that connects two neighboring sides in a straight line may be formed in the fourth face of the cube 100. A rectangular pattern that occupies the entire face may be formed in the fifth face of the cube 100. A pattern that connects three neighboring sides in a straight line may be formed in the sixth face of the cube 100.

However, the patterns formed in the respective faces of the cube 100 are merely examples described with reference to FIG. 2.

In FIG. 1, only one cube 100 has been illustrated, but a plurality of cubes may be arranged in the peripheral area of the terminal device 200. The plurality of arranged cubes may provide a given shape through a combination of the faces of respective patterns formed on the planes of the cubes.

For example, a plurality of cubes may be arranged in an N*N (N-by-N) matrix->N*M(N-by-M) matrix (N is a natural number greater than 2), and may provide Hanguel consonants and vowels, the capital letters and small letters of the alphabet, Arabic numerals, operators, Chinese characters, and other given shapes.

A user reproduces the same shape as a target shape by combining a plurality of the cubes 100, thus being capable of learning the target shape and also developing thinking skills, creativity and intelligence.

In accordance with an embodiment of the present invention, the cube 100 and the terminal device 200 are connected using a short-distance wireless communication scheme. The terminal device 200 may recognize a pattern of the cube 100 based on information received from the cube 100.

For example, when a user positions a given face of the cube 100 right side up in front of the terminal device 200, information for recognizing a pattern formed on the top of the cube may be detected using one or more sensors included in the cube 100. The detected information may be transmitted to the terminal device 200 using short-distance wireless communication.

The terminal device 200 may communicate with the cube 100 or another device (e.g., a case in which a plurality of cubes is disposed) connected to the cube 100 using short-distance wireless communication, and may recognize a pattern of the cube 100 positioned by a user based on information received from the cube 100 or another device connected to the cube 100.

For example, the terminal device 200 may be a computer system, such as a smartphone, a tablet, a personal digital assistant (PDA) or a laptop, but the present invention is not limited thereto.

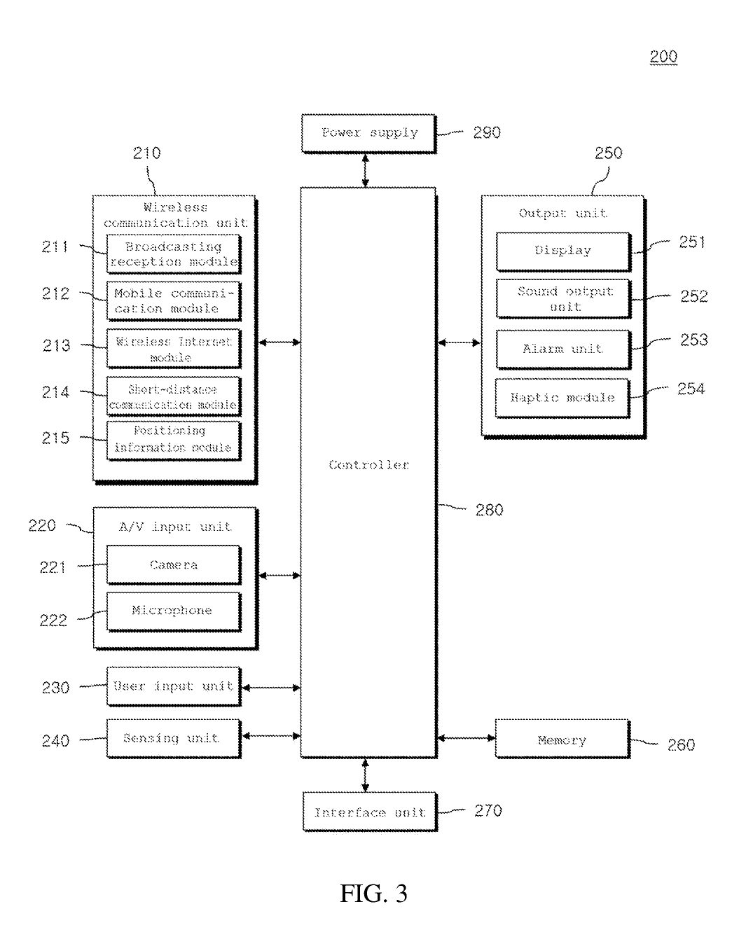

FIG. 3 is a block diagram showing an embodiment of the configuration of the terminal device 200. The terminal device 200 may include a wireless communication unit 210, an audio/video (A/V) input unit 220, a user input unit 230, a sensing unit 240, an output unit 250, memory 260, an interface unit 270, a controller 280 and a power supply 290. The elements of FIG. 3 are not essential elements, and a mobile terminal device having elements fewer or larger than the elements of FIG. 3 may be implemented.

Referring to FIG. 3, the wireless communication unit 210 may include one or more modules that enable wireless communication between the terminal device 200 and a wireless communication system or between the terminal device 200 and a network in which the terminal device 200 has been positioned. For example, the wireless communication unit 210 may include a broadcasting reception module 211, a mobile communication module 212, a wireless Internet module 213, a short-distance communication module 214 and a positioning information module 215.

The broadcasting reception module 211 may receive a broadcasting signal and/or broadcasting-related information from an external broadcasting management server through a broadcasting channel. The mobile communication module 212 transmits/receives a wireless signal to/from at least one of a base station, an external terminal and a server over a mobile communication network.

The wireless Internet module 213 refers to a module for wireless Internet access. The wireless Internet module 213 may be embedded in the terminal device 200 or may be external to the terminal device 200. Various communication schemes, such as a wireless LAN (WLAN) (Wi-Fi), wireless broadband (Wibro), world interoperability for microwave access (Wimax), high speed downlink packet access (HSPDA), and long term evolution (LTE), may be used as the wireless Internet technology.

The short-distance communication module 214 refers to a module for short-distance communication. Bluetooth, radio frequency identification (RFID), infrared data association (IrDA), ultra wideband (UWB) and ZigBee may be used as the short-distance communication technology.

The short-distance communication module 214 of the terminal device 200 is connected to the cube 100 or a case (not shown) in which a plurality of cubes is disposed using a short-distance wireless communication scheme, such as Bluetooth, and may receive information for recognizing a pattern, direction and location of cubes from the cube 100 or the cube case (not shown).

The positioning information module 215 is a module for confirming or obtaining the location of the terminal. The positioning information module 215 may obtain location information using a global navigation satellite system (GNSS). As a representative example of the GNSS, the positioning information module 215 may be a global position system (GPS) module. The GPS module may calculate three-dimensional location information according to the latitude, longitude and altitude of one point (object) on one time by calculating information about the distance of one point (object) from three or more satellites and information about the time when the distance information is measured and applying trigonometry to the calculated distance information.

The A/V input unit 220 is for receiving an audio signal or a video signal, and may include a camera 221 and a microphone 222.

The user input unit 230 generates input data for controlling an operation of the terminal device by a user. The user input unit 230 may include a key pad dome switch, a touch pad (capacitive/resistive), a jog wheel and a jog switch.

The sensing unit 240 senses the current state of the terminal device 200, such as the open/shut state of the terminal device 200, the location of the terminal device 200, whether a user has touched, the orientation of the terminal device and the acceleration/deceleration of the terminal device, and generates a sensing signal for controlling an operation of the terminal device 200.

The sensing unit 240 may include an acceleration sensor and a gyro sensor. Information measured by the sensors may be used to recognize a pattern of the cube 100 and the direction and location of the pattern.

The output unit 250 generates output related to a sense of sight, a sense of hearing or a tactile sense, and may include a display 251, a sound output unit 252, an alarm unit 253 and a haptic module 254.

If the display 251 and a sensor (hereinafter referred to as a “touch sensor”) that senses a touch operation form a mutual layer structure (hereinafter abbreviated as a “touch screen”), the display 251 may also be used as an input device in addition to an output device. The touch sensor may have a form, such as a touch film, a touch sheet or a touch pad, for example.

The display 251 displays a target shape according to a plurality of cubes, and may display whether a cube has been matched with a target shape in the form of an alphabetic latter or an image when a user positions the cube.

The memory 260 may store a program for an operation of the controller 280 and may temporarily store input/output data.

The memory 260 may include a storage medium of at least one type of flash type memory, hard disk type memory, a multimedia card micro type, card type memory (e.g., SD or XD memory), random access memory (RAM), static RAM (SRAM), read-only memory (ROM), electrically erasable programmable ROM (EEPROM), programmable ROM (PROM) magnetic memory, a magnetic disk and an optical disk. The terminal device 200 may also operate in relation to a web storage that performs the storing function of the memory 260 on the Internet.

The interface unit 270 functions as a passage with all of external devices connected to the terminal device 200. The interface unit 270 receives data or power from an external device, and transmits the data or power to each of the elements of the terminal device 200 or enables data within the terminal device 200 to be transmitted to an external device.

In general, the controller 280 controls an overall operation of the terminal device. For example, the controller performs control and processing related to a voice call, data communication and video telephony.

The controller 280 may function to detect a pattern of the cube 100 positioned in front of the terminal device 200 or the direction and location of the pattern based on information received through the short-distance communication module 214.

The power supply 290 receives external power or internal power and supplies power necessary for an operation of each element under the control of the controller 280.

Various embodiments described in this specification may be implemented in a recording medium readable by a computer or similar devices using software or hardware or a combination of them, for example.

In accordance with a hardware implementation, an embodiment described herein may be implemented using at least one of application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electrical units for executing functions. In some cases, such embodiments may be implemented the controller 280.

In accordance with a software implementation, embodiments, such as procedures or functions, may be implemented along with a separate software module for performing at least one function or operation. Software code may be implemented by a software application written in a proper program language. The software code may be stored in the memory 260 and executed by the controller 280.

For example, an application for performing a method of recognizing a cube pattern according to an embodiment of the present invention may be stored in the memory 260, and may be executed by the controller 280 in response to a user's input or the occurrence of a given event.

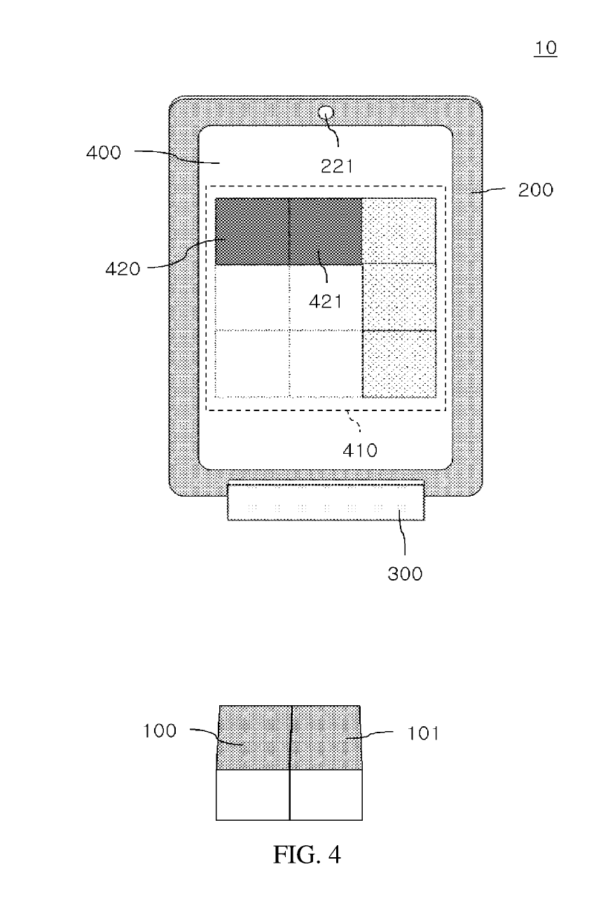

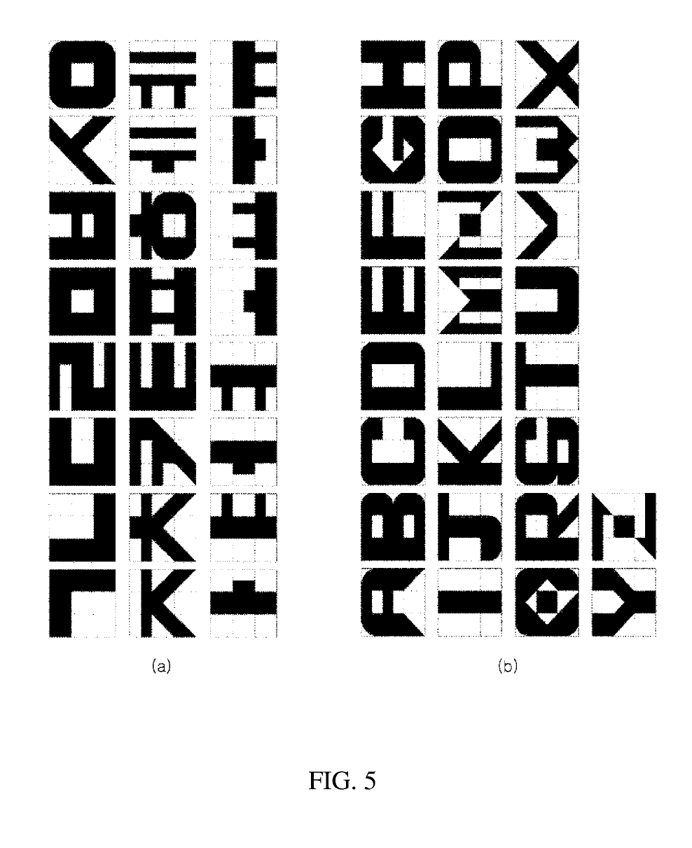

Hereinafter, a schematic operation of the system for recognizing a cube pattern according to an embodiment of the present invention is described with reference to FIG. 4.

A target shape 410 including a plurality of patterns is displayed on a screen 400 of the terminal device 200. A user may combine a plurality of cubes 100 and 101 by disposing the cubes in front of the terminal device 200 with reference to the target shape displayed on the screen of the terminal device 200.

The terminal device 200 may be coupled to a stand 300 and mounted at a given slope with respect to the bottom. A connector (not shown) formed at the top of the stand 300 and the interface unit 270 of the terminal device 200 may be connected to enable the transmission/reception of power supply or other data.

The terminal device 200 may recognize a pattern of the cube 100 arranged by a user, and may display the results of matching on the screen 400 by matching the recognized pattern 420 of the cube 100 with the target shape 410.

In this case, patterns forming the target shape 410 are displayed differently from the patterns 420 and 421 of the cubes 100 and 101 disposed by the user. For example, the patterns may be displayed on the screen 400 with different color, light and shade or transparency.

The user may sequentially combine and dispose the plurality of cubes 100 and 101 with reference to the results of the matching of the patterns displayed on the screen 400 of the terminal device 200 so that the patterns have the same shape as the target shape.

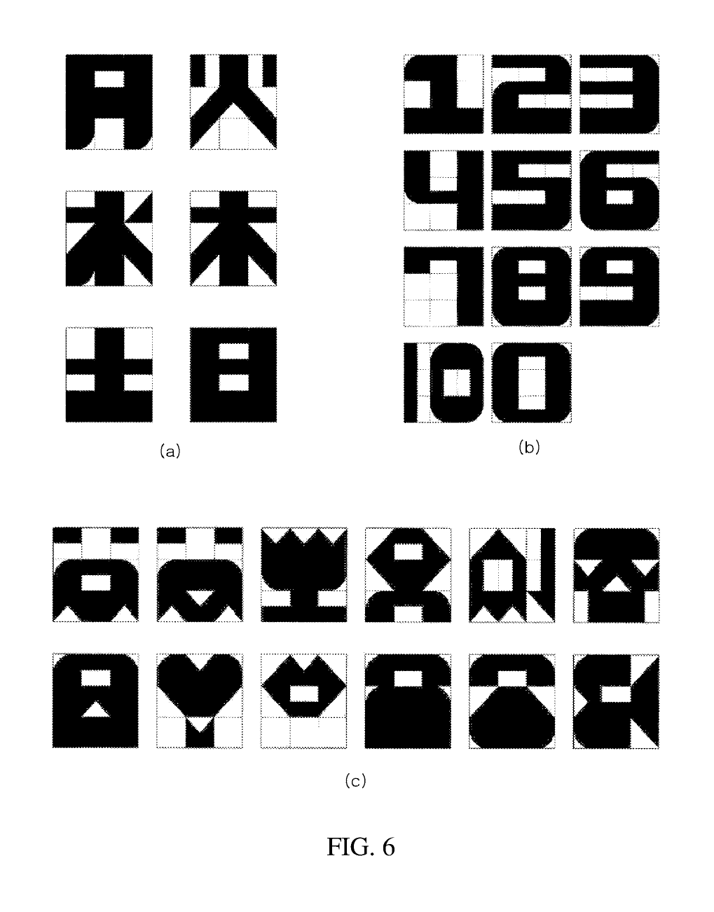

FIGS. 5 and 6 are diagrams showing embodiments of target shapes used in the system 10 for recognizing a cube pattern.

FIG. 5(a) shows exemplary target shapes that represent the consonants and vowels of Hanguel. FIG. 5(b) shows exemplary target shapes that represent alphabetical capital letters.

Furthermore, FIG. 6(a) shows exemplary target shapes that represent Chinese characters. FIG. 6(b) shows exemplary target shapes that represent Arabic numerals. FIG. 6(c) shows exemplary target shapes that represent various images.

The target shapes of FIGS. 5 and 6 include patterns disposed in a 3*3 (3-by-3) matrix, but the present invention is not limited thereto. A target shape may include patterns disposed in an N*N (N-by-N) matrix->N*M (N-by-M) matrix (N is a natural number greater than 2) depending on the difficulty and content of the target shape.

The cube 100 has been illustrated as having a regular hexahedron shape having six faces. The cube 100 according to embodiments of the present invention may be implemented in various stereoscopic shapes having less than 6 faces or 7 or more faces.

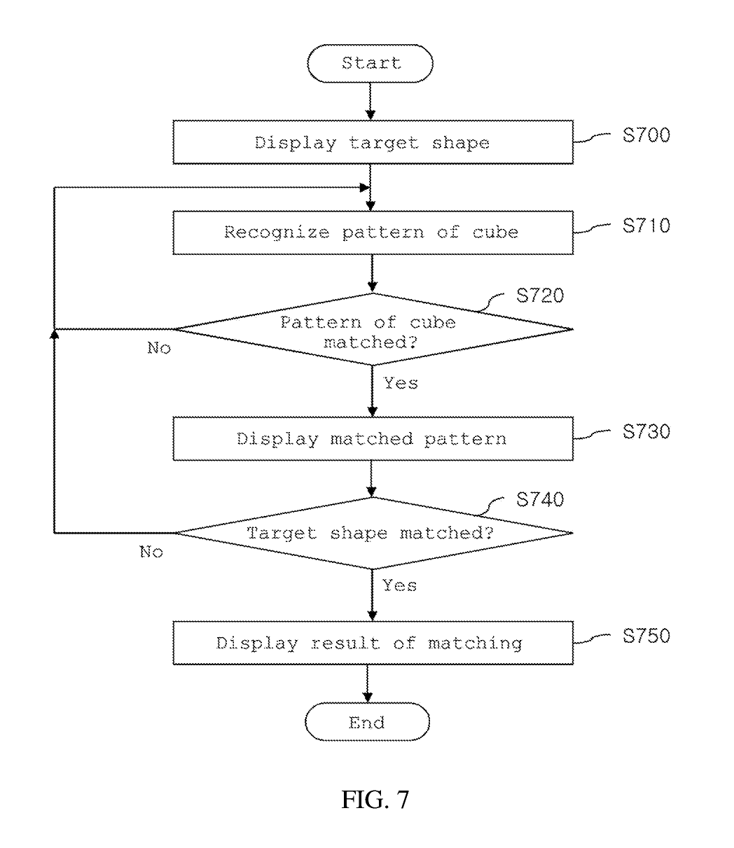

FIG. 7 is a flowchart showing a method of recognizing a cube pattern according to an embodiment of the present invention. The method of recognizing a cube pattern is described in connection with tie block diagram of FIG. 3 shows an embodiment of the configuration of the terminal device 200.

Referring to FIG. 7, the display 251 of the terminal device 200 displays a target shape in which a plurality of patterns has been combined (step S700).

As described above, the target shape may include a plurality of pattern disposed in an N*N (N-by-N) matrix->N*M (N-by-M) matrix (N is a natural number greater than 2).

A user may select a given one of a plurality of target shapes provided by the terminal device 200. Alternatively, the user may directly configure a new target shape and store it in the terminal device 200 or may provide the configured target shape so that the user of another terminal device (not shown) connected over a network may use the configured target shape.

The controller 280 confirms whether a recognized pattern is matched with a pattern of the target shape (step S720) by recognizing a pattern of the cube 100 disposed in front of the terminal device 200 (step S710).

For example, when the user positions a given face of the cube 100 right side up in front of the terminal device 200, the controller 280 of the terminal device 200 may recognize a pattern formed on the top of the cube 100 and the color of the pattern based on information received from the wireless communication unit 210, the AV input unit 220 and the sensing unit 240.

In order to recognize the pattern of the cube 100 at step 710, one of i) a method of recognizing the pattern of the cube 100 based on an image of the cube 100 captured by the camera 221 of the terminal device 200 and ii) a method of recognizing the pattern of the cube 100 based on information received from the cube 100 or a cube case (not shown) through the short-distance communication module 214 of the terminal device 200 or a combination of the two methods may be used.

Thereafter, the controller 280 may compare the recognized pattern with a pattern that belongs to patterns forming the pattern of the target shape and that corresponds to the location of the cube 100 in order to confirm whether the two patterns are matched.

In order to confirm whether the recognized pattern of the cube 100 and the pattern of the target shape are identical, the controller 280 may use a matching template. If the data of the recognized pattern of the cube 100 and the original data of the pattern of the target shape are identical at a given ratio or more, it may be determined that the two patterns are matched.

If, as a result of the confirmation, the recognized pattern of the cube 100 is matched with the pattern of the target shape, the controller 280 displays the corresponding pattern on the display 251 (step S730).

If the recognized pattern of the cube 100 is not matched with the pattern of the target shape, the user may be induced to position the cube 100 again or change the top of the cube.

If steps S710 to S730 are repeatedly performed on a plurality of patterns forming the target shape and thus the entire target shape is matched (step S740), a result of the matching indicating that the matching of the target shape is successful is displayed on the screen 400 of the terminal device 200 (step S750).

In accordance with an embodiment of the present invention, the terminal device 200 periodically receives measurement information detected by a plurality of sensors included in the cube 100 through short-distance wireless communication, and recognizes the type and direction of a pattern formed on the top of the cube. Accordingly, a learning effect can be improved and user convenience can be enhanced.

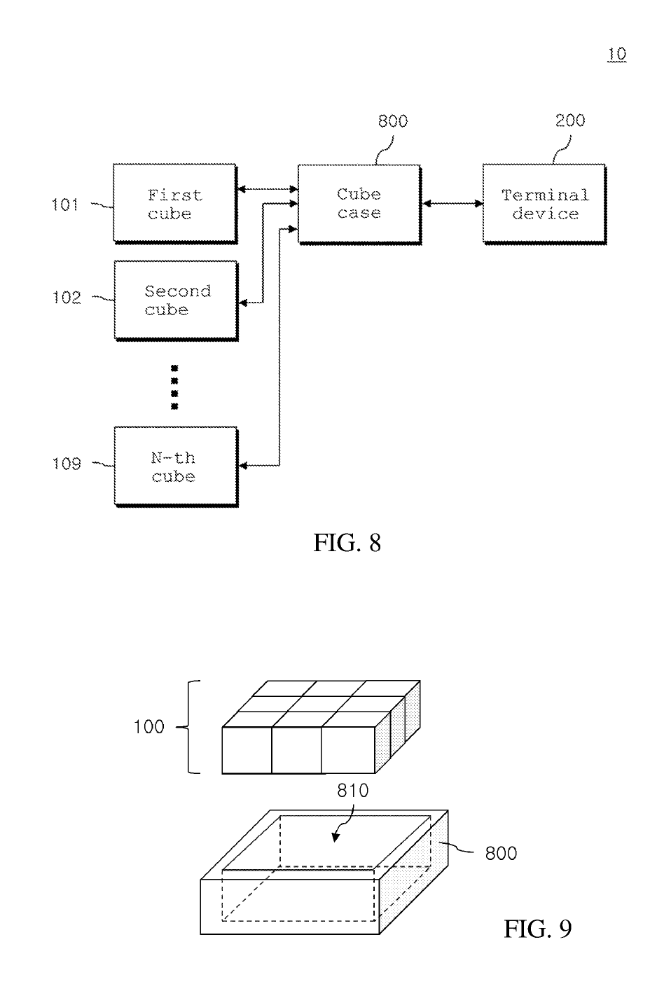

FIG. 8 is a block diagram showing the configuration of a system for recognizing a cube pattern based on short-distance wireless communication according to another embodiment of the present invention. FIG. 9 is a diagram for illustrating an embodiment of the configuration of a cube and cube case shown in FIG. 8. In elements of FIGS. 8 and 9, a description of the same element as that described with reference to FIGS. 1 to 7 is omitted.

Referring to FIGS. 8 and 9, the system 10 for recognizing a cube pattern may include a plurality of cubes 101 to 109, a cube case 800 and the terminal device 200.

As described above, different patterns have been formed in the respective faces of the plurality of cubes 101 to 109. The cubes may be seated in a groove formed in the cube case 800.

A plurality of partition spaces in which the plurality of cubes 101 to 109 is seated may have been formed in the cube case 800.

In accordance with an embodiment of the present invention, one or more magnetic bodies are formed in at least some of a plurality of faces forming the outside of the cube 100. A plurality of magnetic sensors is formed in the partition spaces of the cube case 800, respectively, in such a way as to correspond to the locations of the magnetic bodies.

The terminal device 200 receives magnetism information, detected by the magnetic sensors formed in the respective partition spaces of the cube case 800, from the cube case 800. To this end, the terminal device 200 may be connected to the cube case 800 using a short-distance wireless communication scheme.

The terminal device 200 may recognize the location and pattern of a cube seated in the cube case 800 based on magnetism information of a magnetic sensor from the cube case 800.

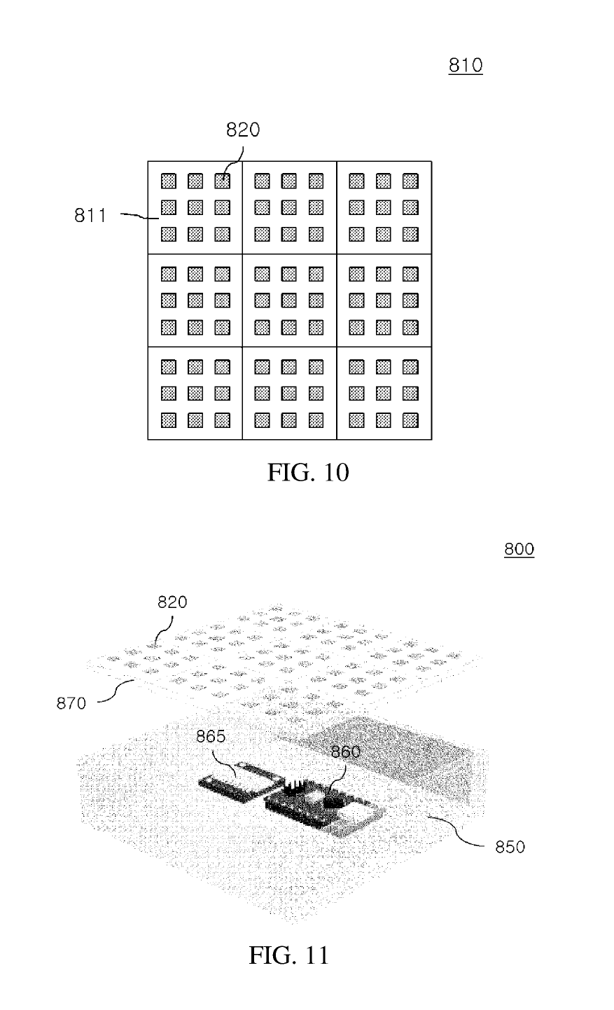

Referring to FIG. 10, the cube case 800 includes a plurality of partition spaces 811 in which the plurality of cubes 101 to 109 may be seated. The same number of magnetic sensors 820 is formed in each of the partition spaces 811.

For example, the cube case 800 may include nine partition spaces 811 in which respective nine cubes 101 to 109 may be seated. Nine magnetic sensors 820 may be formed in each of the partition spaces 811.

FIG. 11 is a diagram showing an embodiment of the internal configuration of the cube case 800.

Referring to FIG. 11, a control board 860 and a Bluetooth module 865 may be provided at the internal bottom of the cube case 800.

The control board 860 functions to control an overall operation of the cube case 800. The control board includes a micro controller, and may include a control board having an interface capable of connection with a sensor.

The Bluetooth module 865 functions to perform short-distance wireless communication with the terminal device 200, and may be connected to the terminal device 200 using a Bluetooth low energy (BLE) communication scheme.

BLE is a wireless communication protocol used to transmit a message with low energy. The BLE specification has been defined in Volume 6 of the Bluetooth specification.

BLE operates in a 2.4 GHz ISM band (2400-2483.5 MHz), that is, a wireless transmission frequency of a short wavelength, and uses 40 RF channels of 2 MHz in the band. Furthermore, BLE may use a radio technology called a frequency-hopping spread spectrum for cutting data to be transmitted into small pieces and transmitting cut lumps through different channels.

Furthermore, BLE transmission may have a transmission range of about 50 m, a data rate of 1 Mb/s, and consumption power of 1%˜50% with respect to the existing Bluetooth.

Although not shown in FIG. 10, the cube case 800 may be equipped with one or more sensors, such as an acceleration sensor, a gyro the sensor and a terrestrial magnetic sensor.

For example, a 3-axis acceleration sensor included in the cube case 800 may be used to recognize the slope of the cube case 800, and a gyro sensor may be used to recognize the rotation of the cube case 800 or the location of the cube case.

Furthermore, the cube case 800 may be equipped with a 2-axis terrestrial magnetic sensor in order to detect the direction of the cube case 800.

As shown in FIG. 10, the sensor board 870 which is divided into the plurality of partition spaces and in which the magnetic sensors are formed in the partition spaces may be positioned at the bottom of the cube case 800.

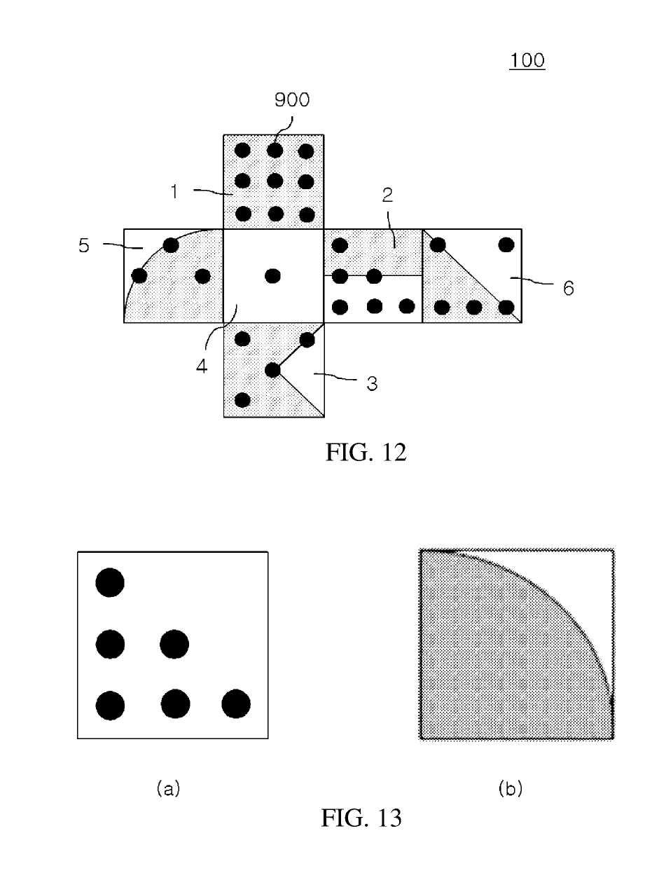

FIG. 12 is a diagram showing an embodiment of the configuration of the faces of the cube in which magnetic bodies have been formed.

Referring to FIG. 12, a different number of magnetic bodies 900 (e.g., permanent magnets) have been formed in each of the faces of the cube 100. The locations of the magnetic bodies formed in the faces may be different.

For example, nine magnetic bodies may have been regularly formed in the first face 1 of the cube 100 in which a rectangular pattern occupying the entire face has been formed. Six magnetic bodies may have been concentrated in a lower left direction and formed in the second face 2 of the cube 100 in which a pattern connecting two facing sides and bisecting a corresponding face has been formed.

Four magnetic bodies may have been concentrated in an upper left direction and formed in the third face 3 of the cube 100 in which a pattern connecting three neighboring sides in a straight line has been formed. One magnetic body may have been formed in the middle of the fourth face 4 of the cube 100, that is, a blank face.

Furthermore, three magnetic bodies may have been formed on the upper side in the fifth side 5 of the cube 100 in which a pattern of a fan shape connecting two neighboring sides in a curve has been formed. Two magnetic bodies and three magnetic bodies may have been formed in the sixth face 6 of the cube 100 in which a pattern of an isosceles triangle connecting two neighboring sides in a straight line has been formed on the upper side and lower side, respectively.

As described above, the number or location of magnetic bodies formed in the faces of the cube 100 is different. Accordingly, a pattern (e.g., the type and direction of a pattern) of the cube 100 may be recognized based on the number or location of magnetic sensors that belong to magnetic sensors formed in the partition spaces of the cube case 800 and have detected magnetism of a reference value or more.

That is, when the cube 100 is seated in a given partition space of the cube case 800, magnetism generated from one or more magnetic bodies formed at the bottom of the seated cube 100 may be detected by a plurality of magnetic sensors formed in the given partition space.

In this case, the intensity of magnetism detected by the magnetic sensors formed in the given partition space may be different depending on the locations of the magnetic bodies formed at the bottom of the cube 100.

Each of the magnetic sensors formed at locations corresponding to the magnetic bodies formed at the bottom of the cube 100 detect magnetism of a preset reference value or more. A distribution of the magnetism of the preset reference value or more detected by the magnetic sensors formed in the partition spaces of the cube case 800 is identical with a distribution of the magnetic bodies formed at the bottom of the cube 100.

For example, when a user seats the cube 100 in the first partition space 811 (refer to FIG. 15) of the cube case 800 by lowering the second face 2 of the cube 100 shown in FIG. 12, a distribution of magnetism, such as that shown in FIG. 13(a), may be detected by the magnetic sensors of the first partition space 811.

In this case, a pattern of the fifth face 5 facing the second face 2 of the cube 100 has been positioned at the location of the first partition space 811 in the direction shown in FIG. 12(b). As a result, the type and direction of a pattern formed on the top of the cube 100 may be recognized.

In accordance with another embodiment of the present invention, a tag having different pattern identification (ID) information may have been formed in each of the faces of the cube.

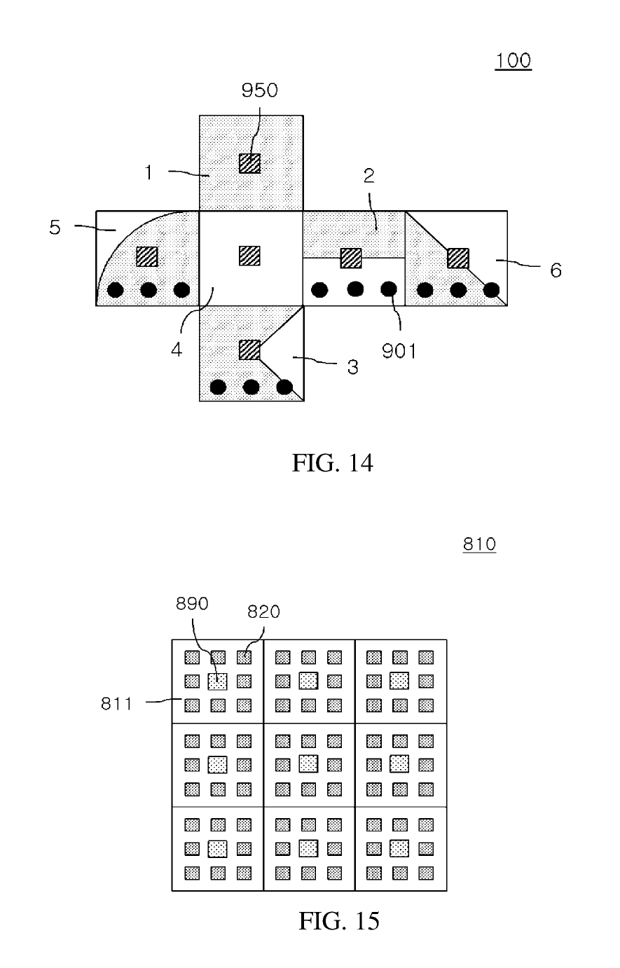

Referring to FIG. 14, an NFC tag 950 has been formed in the middle of each of the plurality of faces forming the outside of the cube 100. The NFC tag 950 may have stored ID information of a corresponding face or ID information of a pattern formed in a corresponding face.

A magnetic body has not been formed in the third face 3 and sixth face 6 facing the first face 1 and fourth face 4 that belong to the faces of the cube 100 and that do not have a direction in their patterns. The same number of magnetic bodies may have been formed in the remaining faces 1, 2, 4 and 5.

In this case, as shown in FIG. 15, an NFC tag reader 890 may have been formed in the middle of each of the partition spaces of the cube case 800 that corresponds to the location of the NFC tag 950 of the cube 100.

When a user seats the cube 100 in a given partition space of the cube case 800, the NFC tag reader 890 formed in the given partition space may read pattern ID information stored in a corresponding NFC tag 950 from the NFC tag 950 formed at the bottom of the cube 100.

For example, when a user seats the cube 100 4 in the first partition space 811 of the cube case 800 by lowering the fourth face 4 of the cube 100 shown in FIG. 14, the NFC tag reader 890 formed in the first partition space 811 reads pattern ID information from a corresponding NFC tag formed in the fourth face 4 of the cube 100.

In this case, a pattern of the sixth face 6 facing the fourth face 4 of the cube 100 may be recognized as being located at the location of the first partition space 811.

Eight magnetic sensors 820 surrounding a corresponding NFC tag reader 890 may have been formed in each of the partition spaces of the cube case 800.

Accordingly, a distribution of magnetism of a reference value or more detected by the eight magnetic sensors formed in the partition space of the cube case 800 is identical with a distribution of the magnetic bodies formed at the bottom of the cube 100. Accordingly, the direction of a pattern formed at the top of the cube 100 can be recognized based on a distribution of magnetism detected by the magnetic sensors.

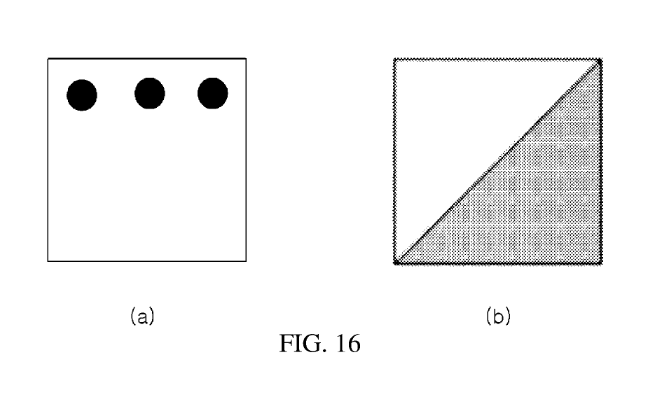

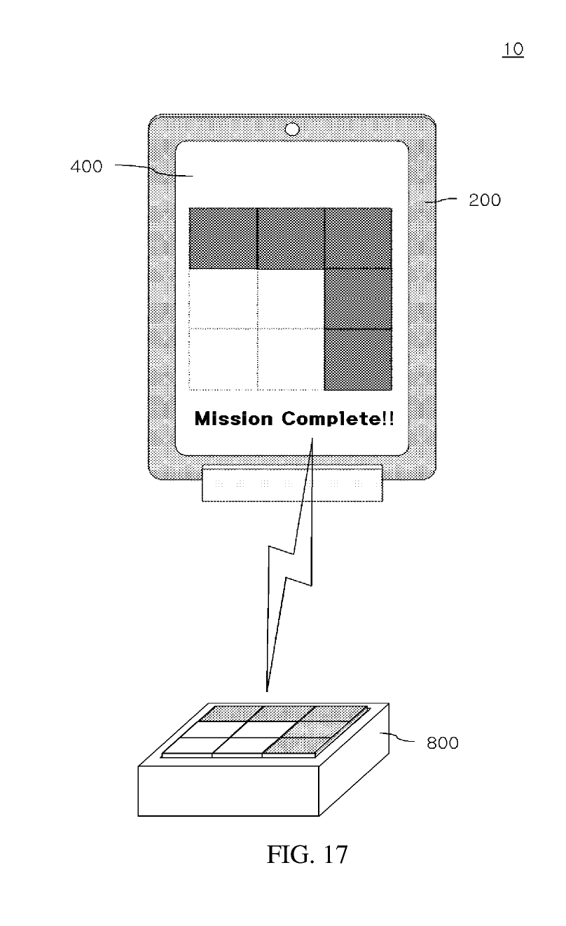

For example, when a user seats the fourth face 2 of the cube 100 shown in FIG. 14 in the first partition space 811 of the cube case 800 by lowering the fourth face 2, a distribution of magnetism, such as that shown in FIG. 16(a), may be detected by the magnetic sensors of the first partition space 811.

In this case, a pattern of the fifth face 5 facing the fourth face 2 of the cube 100 has been positioned at the location of the first partition space 811 in the direction shown in FIG. 16(b). The type and direction of a pattern formed at the top of the cube 100 may be recognized.

In accordance with a method of recognizing a cube pattern according to an embodiment of the present invention, at step S710 of recognizing a cube pattern in FIG. 7, the terminal device 200 may receive magnetism information detected by magnetic sensors from the cube case 800, and may recognize a pattern formed at the top of the cube 100 seated in a given partition space of the cube case 800 based on the received magnetism information of the magnetic sensors.

A method for the terminal device 200 to determine whether a target image and a pattern of cubes are matched by comparing the pattern with the target image after recognizing the type, direction and location of the pattern of the cube 100 may be the same as that described with reference to FIGS. 1 to 7, and a detailed description thereof is omitted.

FIG. 16 is a diagram for illustrating another embodiment of a method of recognizing a pattern of cubes based on magnetism information of magnetic sensors formed in the partition spaces of the cube case.

Referring to FIG. 16, if patterns of cubes seated in the partition spaces of the cube case 800 by a user according to the aforementioned method are recognized for each location and patterns forming a target shape are identical with the patterns of the cubes seated in the cube case 800 for each location, a result of the matching indicating that the target shape has been completed may be displayed on the screen 400 of the terminal device 200.

In accordance with another embodiment of the present invention, the terminal device may automatically perform pairing with a cube case that belongs to a plurality of cube cases disposed around the terminal device and that is successful in the matching of a target shape, thereby being capable of facilitating a connection between the terminal device and a given cube case.

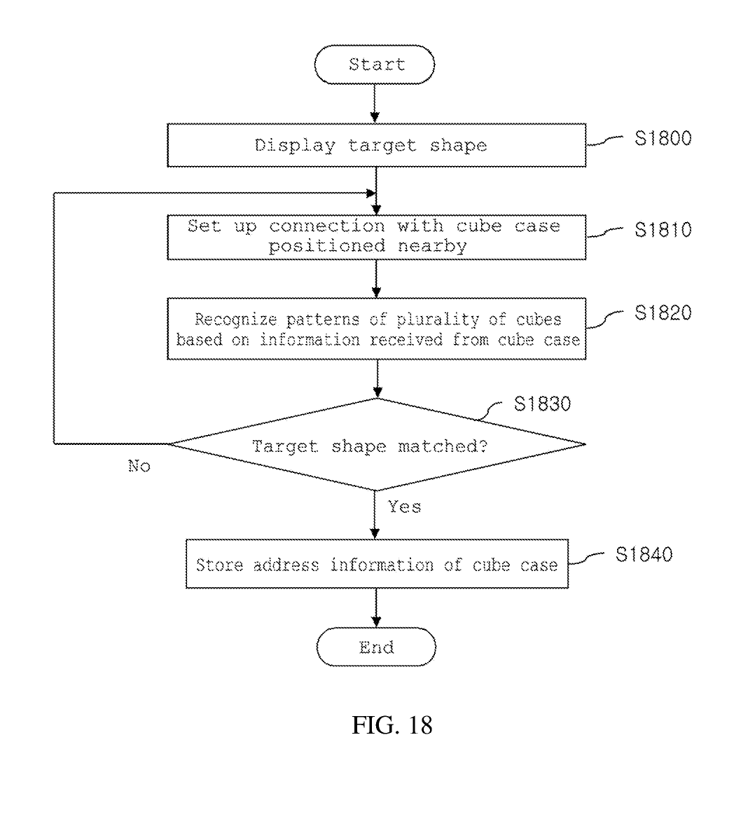

FIG. 18 is a flowchart showing a method of operating in conjunction with a cube case according to an embodiment of the present invention. FIG. 18 shows a method for the terminal device 200 to connect to any one of a plurality of cube cases disposed around the terminal device.

Referring to FIG. 18, the terminal device 200 displays a target shape formed of a plurality of patterns (step S1800).

At step 1800, the target shape is displayed on a screen of the terminal device 200 in order to be automatically paired with a cube case that belongs to a plurality of cube cases disposed around the terminal device 200 and that is specified for use of a user.

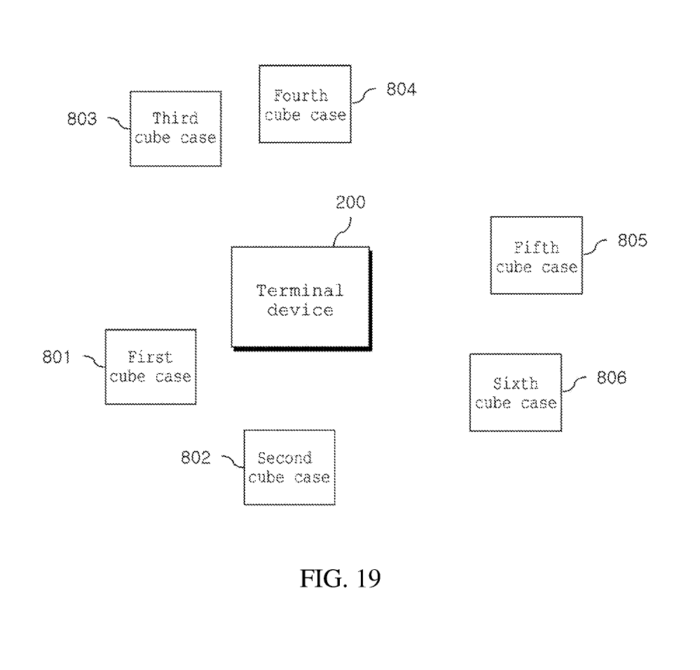

Referring to FIG. 19, a plurality of cube cases 801 to 806 including a cube case to be used by a user may be present around the terminal device 200.

In this case, the terminal device 200 needs to set up a connection by attempting pairing with the cube case to be used by the user from among the plurality of cube cases 801 to 806.

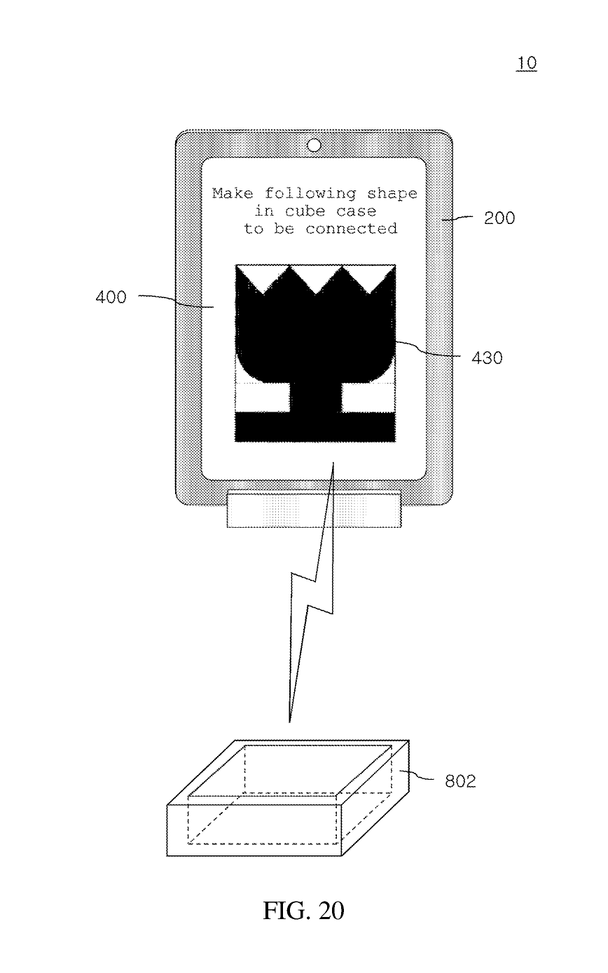

To this end, as shown in FIG. 20, the terminal device 200 may display a target shape 430 for automatic pairing on the screen 400. The user may dispose a plurality of cubes in the cube case 802 to be used so that the cubes are matched with the target shape 430.

After setting up a connection with any one of the cube cases disposed around the terminal device 200 (step S1810), the terminal device 200 recognizes patterns of a plurality of cubes seated in the connected cube case based on information received from the connected cube case (step S1820).

Thereafter, the terminal device 200 confirms whether the recognized patterns of the cubes are matched with patterns of the target shape displayed at step 1800 by comparing the recognized patterns with the patterns of the target shape (step S1830).

If, as a result of the confirmation, matching with the target shape is successful, the terminal device stores address information, such as the Mac Address of the cube case, and terminates a connection process with the cube case (step S1840).

If, as a result of the confirmation, matching with the target shape fails, the terminal device 200 repeats steps 1810 to S1830 on the remaining cube cases until matching with the target shape is successful.

For example, the terminal device 200 may configure a list of surrounding cube cases capable of a connection through Bluetooth, and may search for a cube case that belongs to the cube cases of the list and whose patterns are matched with patterns of a target shape by sequentially repeating steps 1810 to S1830 from the closest cube case.

For example, in the case of FIG. 19, the terminal device 200 may perform pairing with the closest first cube case 801, and may confirm whether patterns of cubes disposed in the closest first cube case are matched with patterns of a target shape.

In this case, if a cube case to be used by a user is the second cube case 802, matching with the target shape with respect to the first cube case 801 fails.

Thereafter, the terminal device 200 performs pairing with the next-closest second cube case 802, and confirms whether patterns of cubes disposed in the second cube case are matched with the patterns of the target shape. If matching with the target shape is successful, the terminal device 200 may store the MAC address of the second cube case 802.

After the MAC address of the second cube case 802 is stored in the terminal device 200 as described above, when the second cube case 802 is positioned around the terminal device 200, pairing between the terminal device 200 and the second cube case 802 is automatically performed and connected.

In order to recognize patterns of cubes seated in cube cases and display them at given locations on the screen 400 of the terminal device 200, the locations need to be designated with respect to the partition spaces of the cube cases.

To this end, each cube case may include a 3-axis terrestrial magnetic sensor to detect the direction of the cube case.

The terminal device 200 receives measurement information detected by the 3-axis terrestrial magnetic sensor from the cube case and recognizes the angle of the cube case based on the received measurement information.

Thereafter, the terminal device 200 may detect the top of the cube case based on the recognized angle.

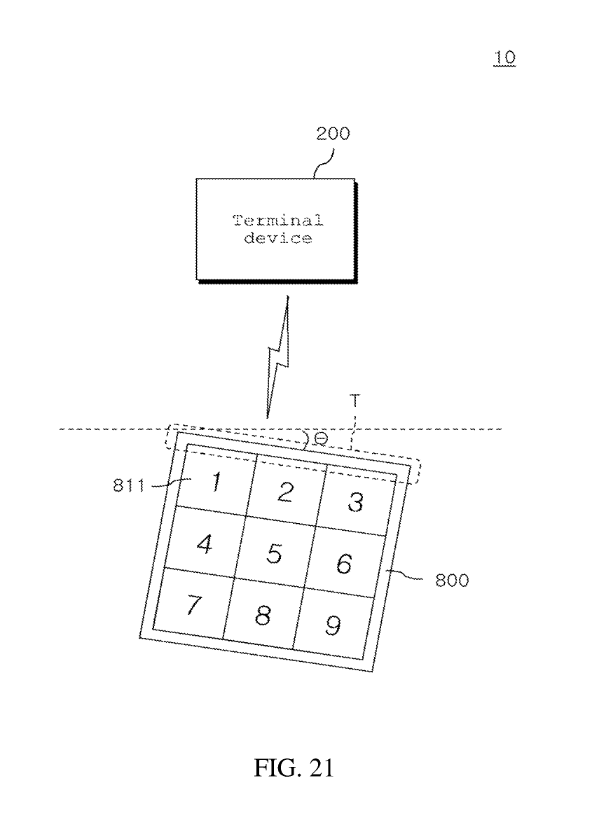

Referring to FIG. 21, the terminal device 200 may receive angle information detected by the 3-axis terrestrial magnetic sensor from the cube case 800, and may calculate the angle θ of the cube case 800 based on the received angle information with respect to the terminal device 200.

The calculated angle θ of the cube case 800 may have a value between 0 degree and 360 degrees. The range of 0 degree to 360 degrees may be divided into four angle areas respectively corresponding to the four outside areas of the cube case 800.

In this case, the top area T of the cube case 800 corresponding to an angle area including the calculated angle θ of the cube case 800 may be detected as the top toward the terminal device 200.

When the top area T of the cube case 800 is detected as described above, the locations of the partition spaces in which the plurality of cubes is seated respectively may be designated based on the detected top area.

For example, as shown in FIG. 21, the locations of the partition spaces may be sequentially designated starting from a left top with respect to the top area T of the cube case 800.

The aforementioned method of the present invention may be produced in the form of a program to be executed by a computer and may be stored in a computer-readable recording medium. The computer-readable recording medium may include ROM, RAM, CD-ROM, a magnetic tape, a floppy disk, and an optical data storage device, for example. Furthermore, the computer-readable recording medium includes media implemented in the form of carrier waves (e.g., transmission through the Internet).

The computer-readable recording medium may be distributed to computer systems connected over a network, and computer-readable code may be stored and executed in a distributed manner. Furthermore, a functional program, code and code segments for implementing the method may be easily reasoned by programmers those skilled in the art to which the present invention pertains.

In accordance with the embodiments of the present invention, a user can learn a target shape and also develop thinking skills, creativity and intelligence by reproducing the same shape as a target shape by combining a plurality of cubes.

Furthermore, the terminal device receives magnetism information of magnetic sensors from a plurality of partition spaces in which a plurality of cubes is respectively seated and a cube case equipped with a plurality of magnetic sensors formed in each of the partition spaces using short-distance wireless communication, and determines the patterns and locations of the cubes. Accordingly, a learning effect can be improved, and user convenience can also be enhanced.

In accordance with another embodiment of the present invention, a connection between the terminal device and a given cube case can be easily set up because the terminal device automatically performs pairing with the given cube case that belongs to a plurality of cube cases disposed nearby and that is successful in matching with a target shape.

The effects of the present invention are not limited to the aforementioned effects, and various other effects may be evidently understood by those skilled in the art from the following description.

Furthermore, although the preferred embodiments of the present invention have been illustrated and described above, the present invention is not limited to the aforementioned given embodiments, and may be modified in various ways by a person having ordinary skill in the art to which the present invention pertains without departing from the gist of the present invention claimed in the claims. Such modified embodiments should not be individually understood from the technical spirit or prospect of this specification.

1. A cube set operating in conjunction with a terminal device using short-distance wireless communication, comprising:
a plurality of cubes having different patterns formed on faces; and
a cube case in which a plurality of partition spaces where the plurality of cubes is respectively seated has been formed,
wherein one or more magnetic bodies are formed in at least some of the faces of the cube, and
a plurality of magnetic sensors is formed in each of the partition spaces of the cube case.

2. The cube set of claim 1, wherein a different number of magnetic bodies are formed in each of the faces of the cube.

3. The cube set of claim 1, wherein one or more magnetic bodies are formed at different locations of the faces of the cube.

4. The cube set of claim 1, wherein an identical number of the magnetic sensors are formed in the partition spaces of the cube case.

5. The cube set of claim 1, wherein the magnetic sensors are formed at locations corresponding to locations of the magnetic bodies formed in each of the faces of the cube.

6. The cube set of claim 1, wherein the cube case comprises a short-distance communication module for transmitting magnetism information detected by the magnetic sensors to the terminal device.

7. The cube set of claim 1, wherein patterns of the cubes seated in the partition spaces are recognized based on a number or locations of magnetic sensors having magnetism of a reference value or more from among the magnetic sensors formed in the partition spaces of the cube case.

8. The cube set of claim 1, wherein a tag having different pattern ID information is formed in each of the faces of the cube.

9. The cube set of claim 8, wherein a tag reader for reading pattern ID information from the tag formed in each of the faces of the cube is formed in each of the partition spaces of the cube case.

10. A method of recognizing patterns of cubes in a terminal device capable of short-distance wireless communication, the method comprising:
displaying a target shape having a plurality of patterns;
receiving magnetism information detected by magnetic sensors from a plurality of partition spaces in which a plurality of cubes is respectively seated and a cube case equipped with the plurality of magnetic sensors formed in the partition spaces;
recognizing a pattern formed on a top of the cube based on the received magnetism information of the magnetic sensors;
confirming whether any one of the patterns forming the target shape is matched with the recognized pattern of the cube; and
displaying a result of the matching.

11. The method of claim 10, wherein recognizing the pattern comprises recognizing patterns of the cubes seated in the partition spaces based on a number or locations of magnetic sensors having magnetism of a reference value or more from among the magnetic sensors formed in the partition spaces of the cube case.

12. A recording medium on which a program for executing a method according to claim 10 is recorded.

13. A system for recognizing a cube pattern, comprising:
a plurality of cubes having different patterns on respective faces, wherein one or more magnetic bodies are formed in at least some of the faces;
a cube case in which a plurality of partition spaces where the plurality of cubes is respectively seated is formed and a plurality of magnetic sensors is formed in each of the partition spaces; and
a terminal device receiving magnetism information detected by the magnetic sensors from the cube case and recognizing a pattern formed on a top of the cube based on the received magnetism information of the magnetic sensors.

14. The system of claim 13, wherein a different number of magnetic bodies are formed in each of the faces of the cube.

15. The system of claim 13, wherein one or more magnetic bodies are formed at different locations of the faces of the cube.

16. The system of claim 13, wherein an identical number of the magnetic sensors are formed in the partition spaces of the cube case.

17. The system of claim 13, wherein the magnetic sensors are formed at locations corresponding to locations of the magnetic bodies formed in each of the faces of the cube.

18. The system of claim 13, wherein the terminal device recognizes patterns of the cubes seated in the partition spaces based on a number or locations of magnetic sensors having magnetism of a reference value or more from among the magnetic sensors formed in the partition spaces of the cube case.

19. The system of claim 13, wherein a tag having different pattern ID information is formed in each of the faces of the cube.

20. The system of claim 13, wherein a tag reader for reading pattern ID information from the tag formed in each of the faces of the cube is formed in each of the partition spaces of the cube case.
